(19) United States
(12) Patent Application Publication
(10) Pub. No.: US 2025/0298611 A1
(43) Pub. Date: Sep. 25, 2025

(54) SYSTEM AND METHOD FOR GENERATING INFORMATION IDENTIFYING A SET OF TASKS ASSOCIATED WITH THE DEVELOPMENT OF A FEATURE OF SOFTWARE USING A SET OF ARTIFICIAL INTELLIGENCE (AI) BOTS

(71) Applicant: Fidelity Information Services, LLC, Jacksonville, FL (US)

(72) Inventors: Guy BROWN, Christchurch (NZ); Nathaniel FLICK, Christchurch (NZ); Vicarum SAMUEL, Tampines (SG); Iain PRIOR, Christchurch (NZ)

(21) Appl. No.: 18/612,516

(22) Filed: Mar. 21, 2024

(51) Int. Cl. G06F 8/77; G06F 8/35

(52) U.S. Cl. CPC G06F 8/77; G06F 8/35

(57) ABSTRACT

A method may include receiving information identifying a feature of software to be developed based on the information being input via an agile software development interface of a user interface of a user device; receiving information identifying a set of artificial intelligence (AI) bots to generate information identifying a set of tasks associated with development of the feature of the software based on the information being input via an AI bot interface of the user interface of the user device; generating the information identifying the set of tasks associated with the development of the feature of the software using the set of AI bots; and transmitting the information identifying the set of tasks to the user device to cause the user device to display the information identifying the set of tasks via the agile software development interface of the user interface of the user device.

### TECHNICAL FIELD

The present disclosure relates to a system and method for displaying a user interface including an agile software development interface and an AI bot interface, receiving a user input via the agile software development interface identifying a feature of software to be developed, generating information identifying a set of tasks associated with the development of the feature of the software using a set of AI bots selected from the AI bot interface, and displaying the information identifying the set of tasks in the agile software development interface.

### BACKGROUND

Agile software development may refer to a software development practice including a collaborative effort between a cross-functional software development team and an end user. In some cases, the end user may request a feature of software to be developed by the software development team. Generally, the software development team may use an agile software development application to assist during the agile software development process. For instance, the software development team might use the agile software development application to delineate a set of tasks associated with the development of the feature of the software, assign various tasks to certain members of the software development team, monitor progress of the various tasks, ensure compliance of the software, etc.

### SUMMARY

According to an embodiment, a method may include receiving information identifying a feature of software to be developed based on the information identifying the feature being input via an agile software development interface of a user interface of a user device; receiving information identifying a set of artificial intelligence (AI) bots to generate information identifying a set of tasks associated with development of the feature of the software based on the information identifying the set of AI bots being input via an AI bot interface of the user interface of the user device; generating the information identifying the set of tasks associated with the development of the feature of the software using the set of AI bots; and transmitting the information identifying the set of tasks to the user device to cause the user device to display the information identifying the set of tasks via the agile software development interface of the user interface of the user device.

According to an embodiment, a device may include a memory configured to store instructions; and one or more processors configured to execute the instructions to perform operations comprising: receiving information identifying a feature of software to be developed based on the information identifying the feature being input via an agile software development interface of a user interface of a user device; receiving information identifying a set of artificial intelligence (AI) bots to generate information identifying a set of tasks associated with development of the feature of the software based on the information identifying the set of AI bots being input via an AI bot interface of the user interface of the user device; generating the information identifying the set of tasks associated with the development of the feature of the software using the set of AI bots; and transmitting the information identifying the set of tasks to the user device to cause the user device to display the information identifying the set of tasks via the agile software development interface of the user interface of the user device.

According to an embodiment, a non-transitory computer-readable medium may store instructions that, when executed by one or more processors of a device, cause the one or more processors to perform operations comprising: receiving information identifying a feature of software to be developed based on the information identifying the feature being input via an agile software development interface of a user interface of a user device; receiving information identifying a set of artificial intelligence (AI) bots to generate information identifying a set of tasks associated with development of the feature of the software based on the information identifying the set of AI bots being input via an AI bot interface of the user interface of the user device; generating the information identifying the set of tasks associated with the development of the feature of the software using the set of AI bots; and transmitting the information identifying the set of tasks to the user device to cause the user device to display the information identifying the set of tasks via the agile software development interface of the user interface of the user device.

It may be understood that both the foregoing general description and the following detailed description are examples and are not restrictive of the disclosed embodiments, as claimed.

### BRIEF DESCRIPTION OF THE DRAWINGS

FIG. 1 is a diagram of an example system for generating information identifying a set of tasks associated with development of a feature of software using a set of AI bots.

FIG. 2 is a diagram of example components of one or more devices of FIG. 1.

FIG. 3 is a flowchart of an example process for displaying a user interface associated with generating information identifying a set of tasks associated with development of a feature of software using a set of AI bots.

FIGS. 4A-4C are diagrams of an example user interface associated with generating information identifying a set of tasks associated with development of a feature of software using a set of AI bots.

FIG. 5 is a flowchart of an example process for generating information identifying a set of tasks associated with development of a feature of software using a set of AI bots.

FIG. 6 is a diagram of an example configuration of a set of AI bots.

FIG. 7 is a diagram of an example process for training, deploying, and monitoring a set of AI bots.

FIG. 8 is a flowchart of an example process for generating code to implement a feature of software using a set of AI bots.

### DETAILED DESCRIPTION

As described above, a software development team may use an agile software development application to assist during an agile software development process, such as by delineating a set of tasks associated with the development of the feature of the software, assigning various tasks to certain members of the software development team, monitoring progress of the various tasks, ensuring compliance of the software, etc. The process of delineating the set of tasks is often time consuming, complex, and error-prone. Further, the process might require various personnel having expertise in specific areas in order to accurately and comprehensively delineate the set of tasks. In light of the foregoing, in some cases, the delineated set of tasks is incomplete, inaccurate, non-comprehensive, non-compliant, etc. Accordingly, the developed feature of the software might not be comprehensive, might not comply with various technical requirements, might be error-prone, or the like.

Some embodiments herein provide a system and method for generating information identifying a set of tasks associated with the development of a feature of software using a set of AI bots. According to an embodiment, a user device may display a user interface including an agile software development interface and an AI bot interface. The user device may receive a user input identifying a feature of software to be developed, and may receive a user input identifying a selection of a set of AI bots to generate information identifying a set of tasks associated with development of the feature of the software. The user device may transmit the information identifying the feature of the software and information identifying the selection of the set of AI bots to an AI bot platform.

The AI bot platform may receive the information identifying the feature of the software and the information identifying the selection of the set of AI bots, and generate information identifying the set of tasks associated with the development of the software using the set of AI bots. The AI bot platform may transmit the information identifying the set of tasks to the user device. The user device may display, via the agile software development interface, the information identifying the set of tasks. The user device may receive a user input that causes the agile software development application to be updated based on the information identifying the set of tasks.

In this way, some embodiments herein improve the accuracy of task delineation, reduce an amount of errors associated with task delineation, reduce the expertise needed for task delineation, reduce the amount of time needed for task delineation, etc. Further, in this way, some embodiments herein may result in software that is more comprehensive, that more sufficiently complies with various technical requirements, that is less error-prone, or the like.

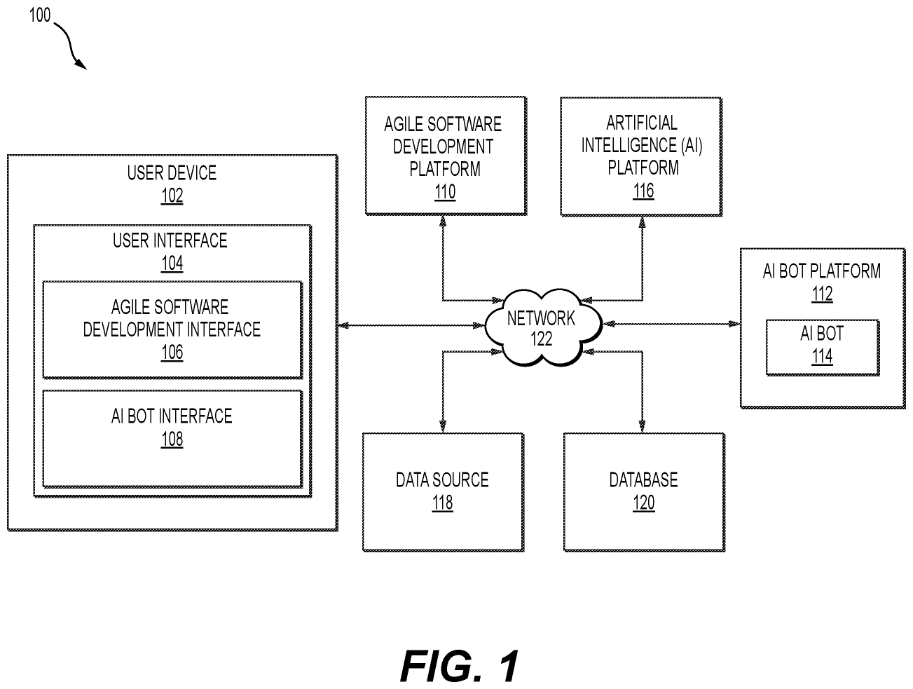

FIG. 1 is a diagram of an example system 100 for generating a set of tasks associated with development of a feature of software using a set of AI bots.

As shown in FIG. 1, the system 100 may include a user device 102, a user interface 104, an agile software development interface 106, an AI bot interface 108, an agile software development platform 110, an AI bot platform 112, an AI bot 114, an AI platform 116, a data source 118, a database 120, and a network 122.

The user device 102 may be configured to display the user interface 104 including the agile software development interface 106 and the AI bot interface 108. For example, the user device 102 may be a personal computer, a smartphone, a tablet computer, or the like. The agile software development interface 106 may be a user interface associated with an agile software development application provided by the agile software development platform 110. The AI bot interface 108 may be a user interface associated with an AI bot application provide by the AI bot platform 112.

The agile software development platform 110 may be configured to implement the agile software development application, and permit the user device 102 to access the agile software development application. For example, the agile software development platform 110 may be a server, a cloud server, or the like. The agile software development application may be an application that supports agile software development. For example, the agile software development application may be Jira®, ClickUp®, GitHub®, Asana®, or the like.

The AI bot platform 112 may be configured to implement an AI bot application, and implement the AI bots 114. For example, the AI bot platform 112 may be a server, a cloud server, or the like. The AI bot application may be an application that provides access to the AI bots 114. The AI bots 114 may be applications that are configured to receive information identifying a feature of software to be developed, and generate information identifying a set of tasks associated with the development of the feature of the software. Each AI bot 114 may be associated with a particular specialty or role associated with the development of the software. For example, the specialty or role may be “quality assurance,” “DevOps,” “user experience,” “SecOps,” or the like.

The data source 118 may be configured to provide entity non-specific information that permits the AI bots 114 to generate the set of tasks associated with the development of the feature of the software. For example, the data source 118 may be a hierarchical database, a network database, a relational database, a server, or the like. The “entity non-specific information” may be information that is generic to multiple entities (e.g., companies, organizations, teams, etc.). For instance, the entity non-specific information may be from publicly-available data sources 118.

The database 120 may be configured to provide entity-specific information that permits the AI bots 114 to generate the set of tasks associated with the development of the feature of the software. For example, the database 120 may be a hierarchical database, a network database, a relational database, or the like. The “entity-specific information” may be information that is specific to an entity associated with the software development team that is developing the software. For instance, the entity-specific information may be internal information to the entity, wiki information of the entity, best practices information of the entity, standards of the entity, compliance information of the entity, internal information of the entity, policy information of the entity, or the like.

The network 122 may be configured to permit communication between the devices of FIG. 1. For example, the network 122 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of the devices of the system 100 shown in FIG. 1 are provided as an example. In practice, the system 100 may include additional devices, fewer devices, different devices, or differently arranged devices than those shown in FIG. 1. Additionally, or alternatively, a set of devices (e.g., one or more devices) of the system 100 may perform one or more functions described as being performed by another set of devices of the system 100.

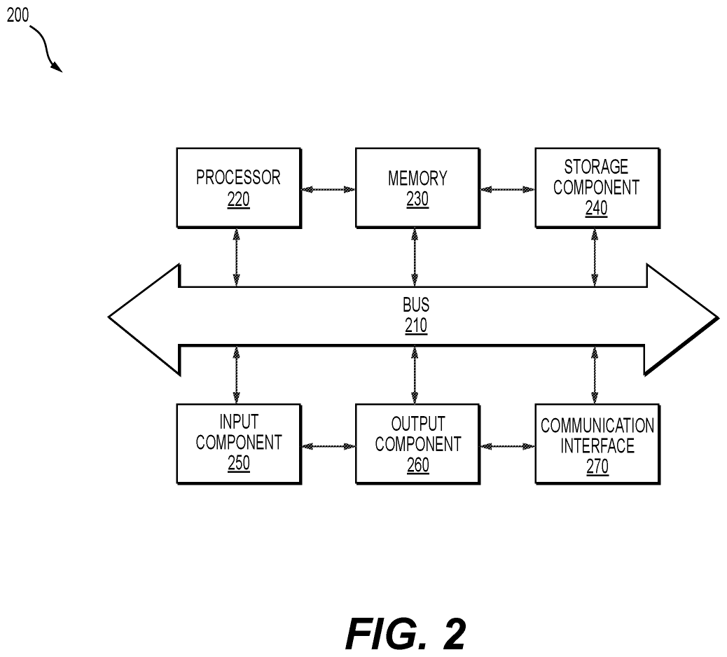

FIG. 2 is a diagram of example components of a device 200 of FIG. 1. The device 200 may correspond to one or more of the devices shown in FIG. 1. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 may be implemented in hardware, firmware, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

The processor 220 may include one or more processors capable of being programmed to perform a function. The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, a camera, and/or a microphone). Additionally, or alternatively, the input component 250 may include a sensor for sensing information (e.g., a global positioning system (GPS) component, an accelerometer, a gyroscope, and/or an actuator). The output component 260 may include a component that provides output information from the device 200 (e.g., a display, a speaker for outputting sound at the output sound level, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes based on the processor 220 executing software instructions stored by a non-transitory computer-readable medium, such as the memory 230 and/or the storage component 240. A computer-readable medium may be defined herein as a non-transitory memory device. A memory device may include memory space within a single physical storage device or memory space spread across multiple physical storage devices.

The software instructions may be read into the memory 230 and/or the storage component 240 from another computer-readable medium or from another device via the communication interface 270. When executed, the software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of the components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

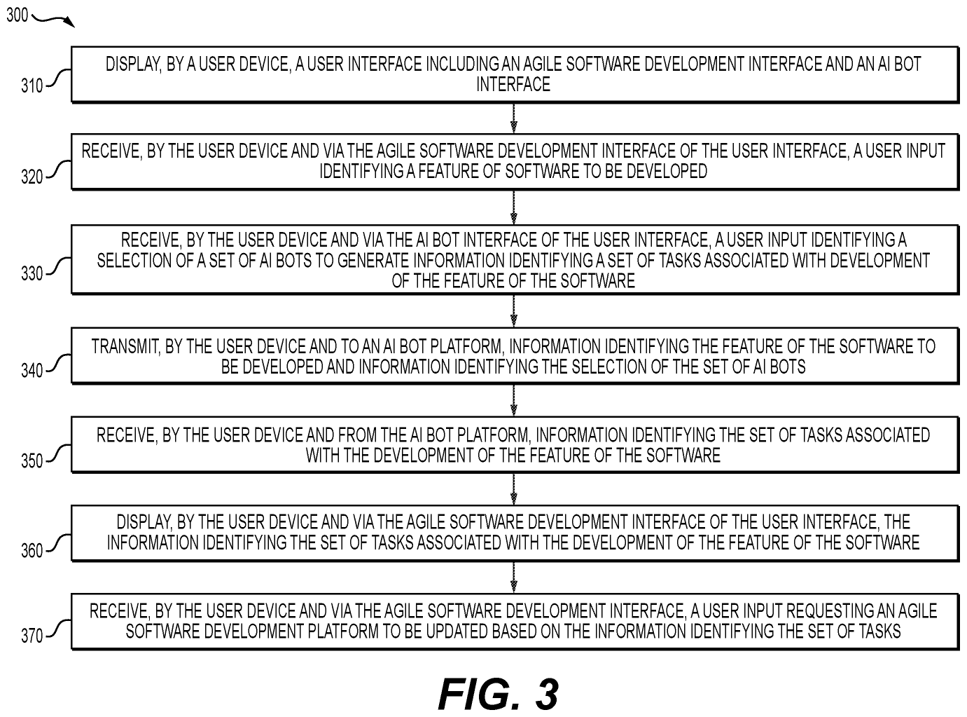

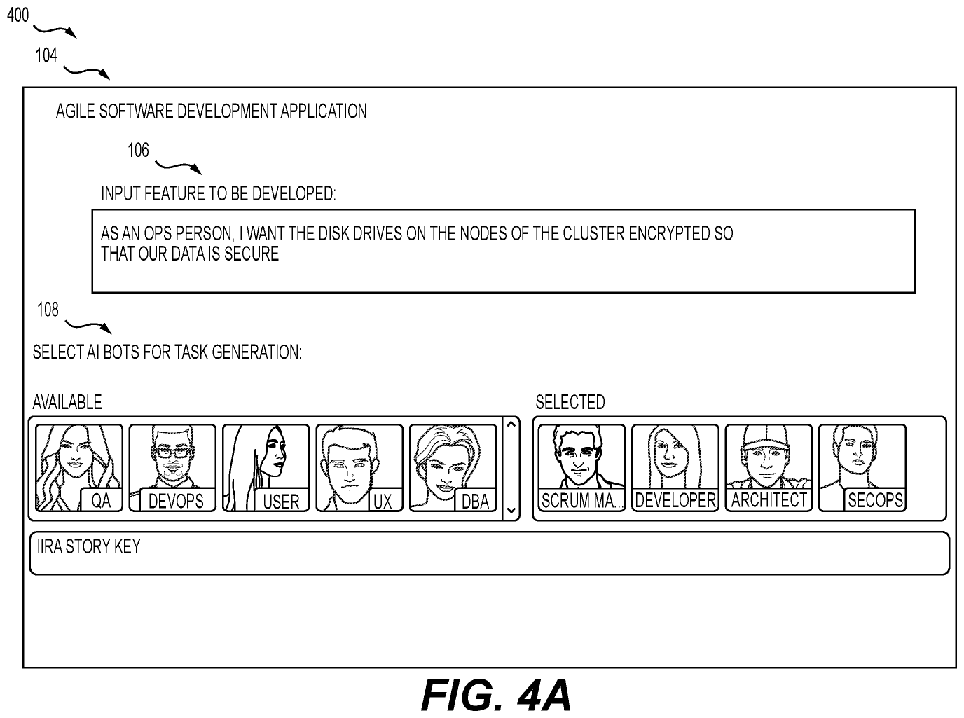

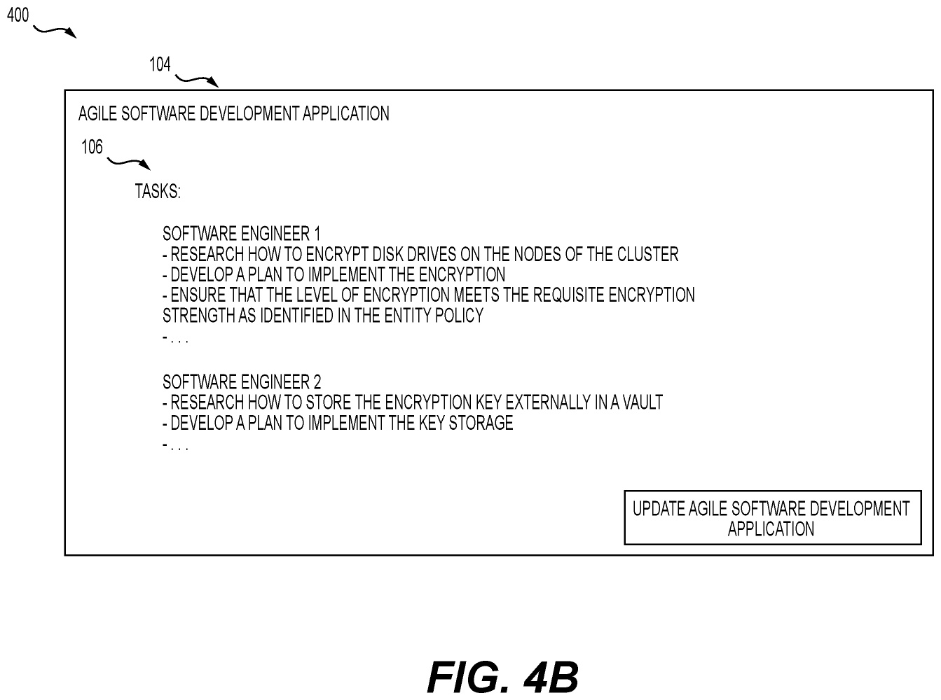

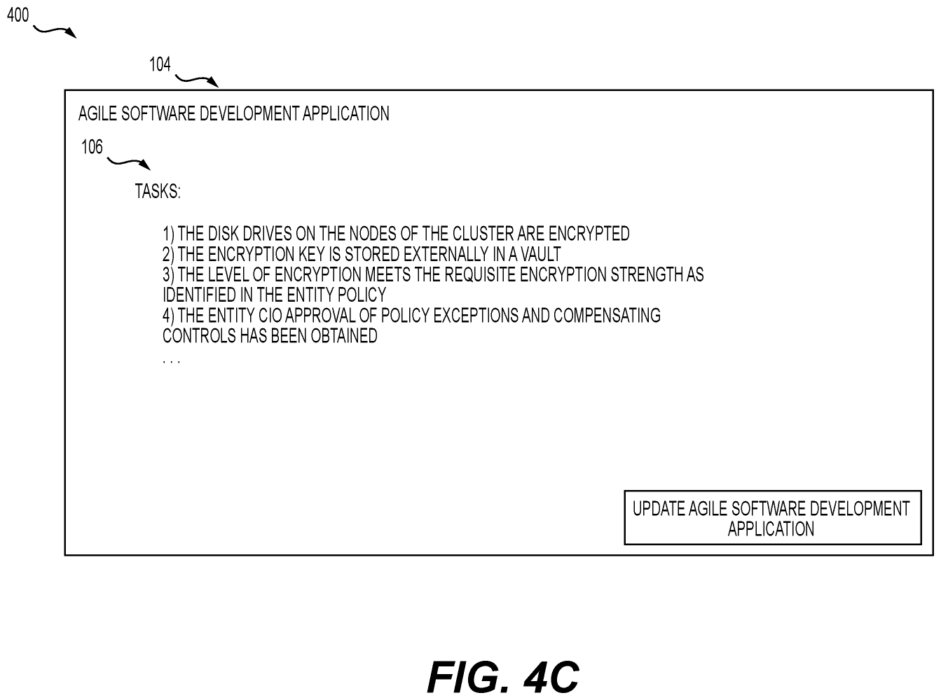

FIG. 3 is a flowchart of an example process 300 for displaying a user interface associated with generating information identifying a set of tasks associated with development of a feature of software using a set of AI bots. FIGS. 4A-4C are diagrams of an example user interface associated with generating information identifying a set of tasks associated with development of a feature of software using a set of AI bots.

As shown in FIG. 3, the process 300 may include displaying, by a user device, a user interface including an agile software development interface and an AI bot interface (operation 310). The user device 102 may display the user interface 104 that includes the agile software development interface 106 and the AI bot interface 108. The user interface 104 may permit both the agile software development interface 106 and the AI bot interface 108 to be viewed in a single user interface. In other words, the user interface 104 may concurrently display the agile software development interface 106 and the AI bot interface 108 in a single user interface. In this way, a user of the user device 102 might not be required to switch between a user interface providing the agile software development application and a separate user interface providing the AI bot application. As an example, and as shown in FIG. 4A, the user interface 104 may include the agile software development interface 106 and the AI bot interface 108 that are displayed concurrently.

As further shown in FIG. 3, the process 300 may include receiving, by the user device and via the agile software development interface of the user interface, a user input identifying a feature of software to be developed (operation 320). The user input identifying the feature of the software to be developed may be a text input that describes the feature of the software to be developed, a voice input that describes the feature of the software to be developed, a selection from a predetermined list of features, or the like. As an example, and as shown in FIG. 4A, the user may input “As an Ops person, I want the disk drives on the nodes of the cluster encrypted so that our data is secure” in the agile software development interface 106 of the user interface 104. In this particular example, the input identifying a feature of software to be developed may be a “story” in the Jira® agile software development application.

As further shown in FIG. 3, the process 300 may include receiving, by the user device and via the AI bot interface of the user interface, a user input identifying a selection of a set of AI bots to generate a set of tasks associated with development of the feature of the software (operation 330). The user input identifying the selection of the set of AI bots 114 may be an input that selects a set (e.g., one or more) of AI bots 114 to generate information identifying the set of tasks associated with the development of the feature of the software. For example, the AI bot interface 108 may display icons associated with the set of AI bots 114, and the user input may be a selection of various icons associated with various AI bots 114. As a specific example, and as shown in FIG. 4A, the AI bot interface 108 may display icons associated with the set of AI bots 114. Further, as shown, the AI bot interface 108 may display a set of selected AI bots 114, and a set of unselected, but available, AI bots 114. As another example, the AI bot interface 108 may display textual information describing the set of AI bots 114, and the user input may be a selection of the textual information. As another example, the user input may be a text input identifying the set of AI bots 114. As another example, the user input may be a text input identifying respective roles for the development of the feature of the software. In this way, a user of the user device 102 may select AI bots 114 corresponding to roles for which the user does not have information for inputting tasks to the agile software development application.

As further shown in FIG. 3, the process 300 may include transmitting, by the user device and to an AI bot platform, information identifying the feature of the software to be developed and information identifying the selection of the set of AI bots to generate information identifying the set of tasks associated with the development of the feature of the software (operation 340), and receiving, by the user device and from the AI bot platform, information identifying the set of tasks associated with the development of the feature of the software (operation 350).

The user device 102 may transmit the information identifying the feature of the software to be developed and the information identifying the set of AI bots 114 to generate information identifying the set of tasks to the AI bot platform 112. According to an embodiment, the user device 102 may transmit information identifying roles of the software development team associated with the development of the software. The roles may correspond to the set of tasks. For instance, respective tasks, of the set of tasks, may be assigned to respective roles of the software development team.

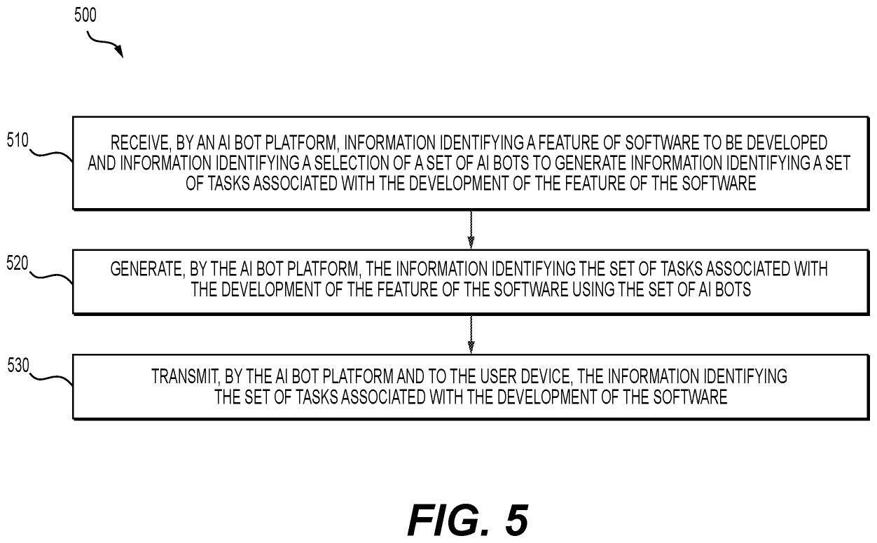

The AI bot platform 112 may generate the information identifying the set of tasks, as described in more detail in association with FIG. 5. The AI bot platform 112 may transmit the information identifying the set of tasks to the user device 102, and the user device 102 may receive the identifying the set of tasks associated with the development of the feature of the software from the AI bot platform 112.

As further shown in FIG. 3, the process 300 may include displaying, by the user device and via the agile software development interface of the user interface, the information identifying the set of tasks associated with the development of the feature of the software (operation 360). The user device 102 may display the user interface 104 including the agile software development interface 106. The agile software development interface 106 may include information identifying the set of tasks associated with the development of the feature of the software.

According to an embodiment, the information identifying the set of tasks may include the set of tasks associated with the development of the feature of the software. The information identifying the set of tasks may identify respective roles of the software development team, and may identify respective tasks associated with the respective roles. For example, as shown in FIG. 4B, the information identifying the set of tasks may identify a first role (“Software Engineer 1”) of the software development team, identify respective tasks associated with the first role (e.g., “Research how to encrypt disk drives on the nodes of the cluster,” “Develop a plan to implement the encryption,” etc.), identify a second role (“Software Engineer 2”) of the software development team, and identify respective tasks associated with the second role (e.g., “Research how to store the encryption key externally in a vault,” “Develop a plan to implement the key storage,” etc.).

According to an embodiment, the information identifying the set of tasks may identify acceptance criteria of the feature of the software to be developed. For example, as shown in FIG. 4C, the information identifying the set of tasks may identify acceptance criteria (e.g., “The disk drives on the nodes of the cluster are encrypted,” “The encryption key is stored externally in a vault,” “The level of encryption meets the requisite encryption strength as identified in the Entity policy,” etc.). According to an embodiment, the information identifying the set of tasks may include a summary of the set of tasks, median story-points, feedback from the software development team, entity policies, etc. According to an embodiment, the information identifying the set of tasks may identify a conversation between the AI bots 114 that generated the information identifying the set of tasks, as described in more detail in connection with FIG. 5.

As further shown in FIG. 3, the process 300 may include receiving, by the user device and via the agile software development interface, a user input requesting an agile software development platform to be updated based on the information identifying the set of tasks associated with the development of the feature of the software (operation 370). The agile software development interface 106 may include a user interface element that permits the agile software development application to be updated based on the information identifying the set of tasks. In this way, a user may select the user interface element, and cause the agile software development application to be updated.

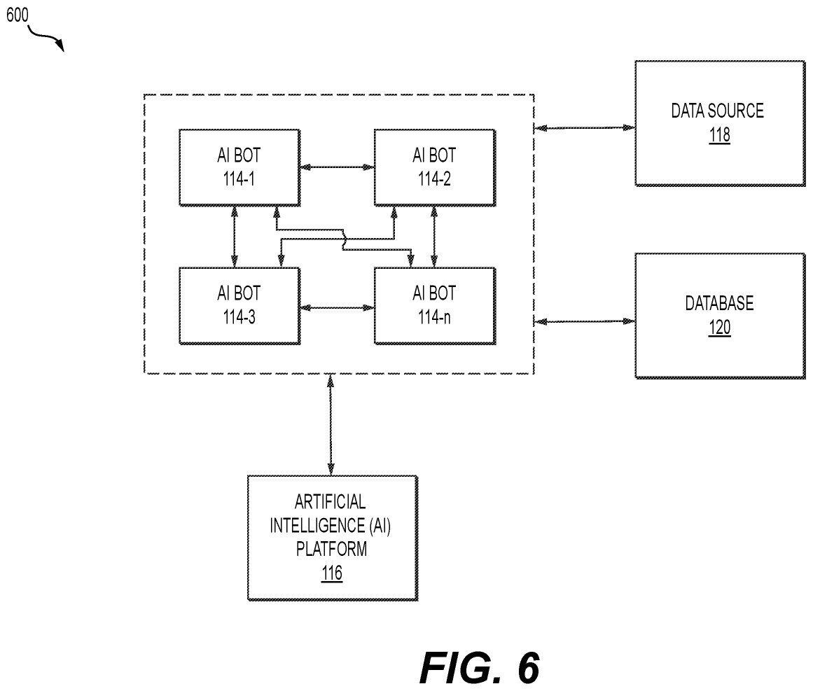

FIG. 5 is a flowchart of an example process 500 for generating a set of tasks associated with development of a feature of software using a set of AI bots. FIG. 6 is a diagram of an example configuration of a set of AI bots.

As shown in FIG. 5, the process 500 may include receiving, by an AI bot platform, information identifying a feature of software to be developed and information identifying a selection of a set of AI bots to generate a set of tasks associated with the development of the feature of the software (operation 510). The AI bot platform 112 may receive the information identifying the feature of the software to be developed and the information identifying the selection of the set of AI bots 114 from the user device 102. According to an embodiment, the AI bot platform 112 may receive information identifying roles of the software development team associated with the development of the software. The roles may correspond to the set of tasks. For instance, respective tasks, of the set of tasks, may be assigned to respective roles.

As shown in FIG. 5, the process 500 may include generating, by the AI bot platform, the information identifying the set of tasks associated with the development of the software using the set of AI bots (operation 520). The AI bot platform 112 may execute the set of AI bots 114 to generate the information identifying the set of tasks. For example, the AI bot platform 112 may determine the set of AI bots 114 to execute based on the information identifying the selection of the set of AI bots 114, and execute the set of AI bots 114.

According to an embodiment, an AI bot 114 may analyze the information identifying the feature of software to be developed, generate a query to the AI platform 116 for information regarding the task, receive a response including the information regarding the task from the AI platform 116, and generate information identifying the task based on the response. For example, as shown in FIG. 6, each of the AI bots 114-1 through 114-n may be configured to communicate with the AI platform 116.

According to an embodiment, an AI bot 114 may analyze the information identifying the feature of software to be developed, generate a query to the data source 118 for information regarding the task, receive a response including the information regarding the task from the data source 118, and generate information identifying the task based on the response. For example, as shown in FIG. 6, each of the AI bots 114-1 through 114-n may be configured to communicate with the data source 118.

According to an embodiment, an AI bot 114 may analyze the information identifying the feature of software to be developed, generate a query to the database 120 for information regarding the task, receive a response including the information regarding the task from the database 120, and generate information identifying the task based on the response. For example, as shown in FIG. 6, each of the AI bots 114-1 through 114-n may be configured to communicate with the database 120.

According to an embodiment, an AI bot 114 may analyze the information identifying the feature of software to be developed, generate a query to another AI bot 114 for information regarding the task, receive a response including the information regarding the task from the AI bot 114, and generate information identifying the task based on the response. In this case, the AI bot 114 that receives the query may analyze the query, generate another query to the data source 118, the database 120, and/or the AI platform 116, receive a response to the query, and transmit a response to the AI bot 114 that provided the query. For example, as shown in FIG. 6, each of the AI bots 114-1 through 114-n may be configured to communicate with each other.

According to an embodiment, an AI bot 114 may generate a query based on a role associated with the AI bot 114. For example, if the AI bot 114 is associated with a role of “user interface developer,” then the AI bot 114 may generate a query that is related to user interface development associated with the feature of the software to be developed.

According to an embodiment, a first AI bot 114 may determine to transmit the query to a second AI bot 114 based on a first role of the first AI bot 114 and a second role of the AI bot 114. For example, if the first role is “quality assurance developer” and the second role is “SecOps,” then the first AI bot 114 may generate a query related to security operations.

According to an embodiment, the AI bots 114 may generate a conversation based on the respective queries and responses between each other. For example, the conversation may identify the respective queries and responses between the AI bots 114 in a natural language format.

As shown in FIG. 5, the process 500 may include transmitting, by the AI bot platform and to the user device, the information identifying the set of tasks associated with the development of the software (operation 530). The AI bot platform 112 may transmit the information identifying the set of tasks to the user device 102 to cause the user device 102 to display the information regarding the set of tasks, as described in connection with FIG. 3.

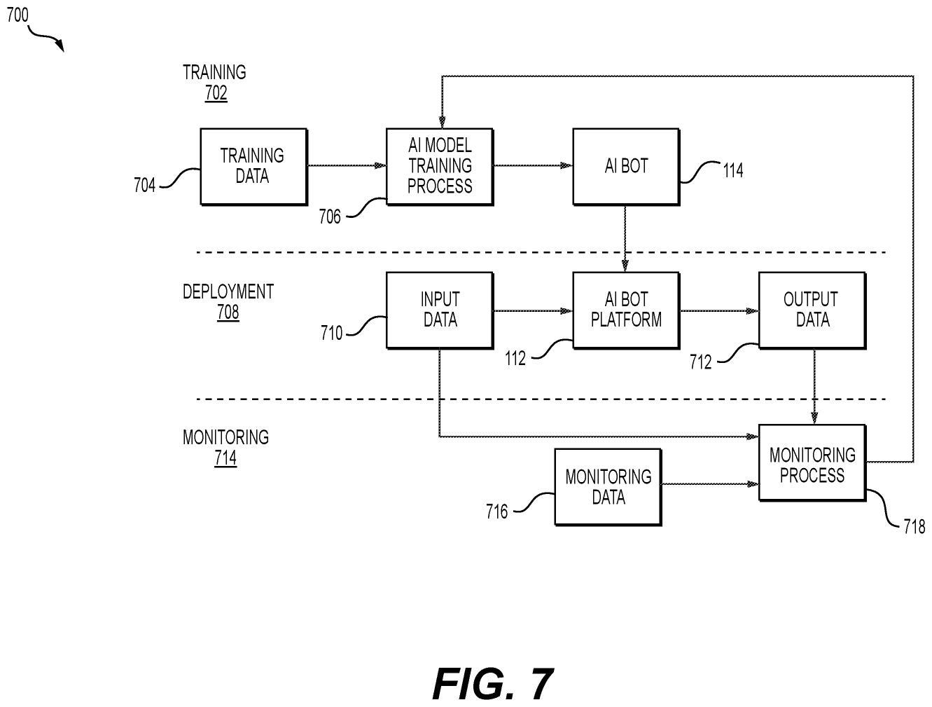

FIG. 7 is a diagram of an example process 700 for training, deploying, and monitoring a set of AI bots. The AI bot platform 112 may generate, store, train, and/or use the set of AI bots 114. According to an embodiment, the AI bot platform 112 may include the set of AI bots 114 and/or instructions associated with the set of AI bots 114. For example, the AI bot platform 112 may include instructions for generating the set of AI bots 114, training the set of AI bots 114, using the set of AI bots 114, etc. According to another embodiment, a system or device other than the AI bot platform 112 may be used to generate and/or train the set of AI bots 114. For example, a system or device may include instructions for generating the set of AI bots 114, and/or instructions for training the set of AI bots 114. The system or device may provide a resulting trained set of AI bots 114 to the AI bot platform 112 for use.

As shown in FIG. 7, according to an embodiment, the process 700 may include a training phase 702, a deployment phase 708, and a monitoring phase 714. In the training phase 702, at operation 706, the process 700 may include receiving and processing training data 704 to generate the set of AI bots 114 for performing one or more operations as described herein. Generally, the set of AI bots 114 may include a set of variables (e.g., nodes, neurons, filters, or the like) that are tuned (e.g., weighted, biased, or the like) to different values via the application of the training data 704. According to an embodiment, the training process at operation 706 may employ supervised, unsupervised, semi-supervised, and/or reinforcement learning processes to train the set of AI bots 114. According to an embodiment, a portion of the training data 1104 may be withheld during training and/or used to validate the set of AI bots 114.

For supervised learning processes, the training data 704 may include labels or scores that may facilitate the training process by providing a ground truth. The set of AI bots 114 may have variables set at initialized values (e.g., at random, based on Gaussian noise, based on pre-trained values, or the like). The set of AI bots 114 may provide an output, and the output may be compared with the corresponding label or score (e.g., the ground truth), which may then be back-propagated through the set of AI bots 114 to adjust the values of the variables. This process may be repeated for a plurality of samples at least until a determined loss or error is below a predefined threshold. According to an embodiment, some of the training data 704 may be withheld and used to further validate or test the set of AI bots 114.

For unsupervised learning processes, the training data 704 may not include pre-assigned labels or scores to aid the learning process. Instead, unsupervised learning processes may include clustering, classification, or the like, to identify naturally occurring patterns in the training data 704. As an example, the training data 704 may be clustered into groups based on identified similarities and/or patterns. K-means clustering or K-Nearest Neighbors may also be used, which may be supervised or unsupervised. Combinations of K-Nearest Neighbors and an unsupervised cluster technique may also be used. For semi-supervised learning, a combination of training data 704 with pre-assigned labels or scores and training data 704 without pre-assigned labels or scores may be used to train the set of AI bots 114.

When reinforcement learning is employed, an agent (e.g., an algorithm) may be trained to make a decision regarding the data quality from the training data 704 through trial and error. For example, based on making a decision, the agent may then receive feedback (e.g., a positive reward if the prediction was above a predetermined threshold), adjust its next decision to maximize the reward, and repeat until a loss function is optimized.

After being trained, the trained set of AI bots 114 may be stored and subsequently applied by the AI bot platform 112 during the deployment phase 708. For example, during the deployment phase 708, the trained set of AI bots 114 may be executed by the AI bot platform 112 and may receive input data 710 for performing one or more operations of any one of the processes described herein.

The monitoring data 716 may include data that is output by the set of AI bots 114. During process 718, the monitoring data 716 may be analyzed along with the predicted output data 712 and input data 710 to determine an accuracy of the trained set of AI bots 114. According to an embodiment, based on the analysis, the process 700 may return to the training phase 702, where at operation 706 values of one or more variables of the model may be adjusted to improve the accuracy of the set of AI bots 114.

The example process 700 described above is provided merely as an example, and may include additional, fewer, different, or differently arranged aspects than depicted in FIG. 7.

According to an embodiment, the AI bot platform 114 may access a pre-trained AI model (e.g., a large language model (LLM)), and use retrieval augmented generation (RAG) to connect to various data sources 118 (e.g., Mindtouch®, Sharepoint®, JIRA®, ServiceNow®, or the like) based on personas of the AI bots 114 to populate fields of the agile software development interface 106.

According to an embodiment, the AI bot platform 114 may generate and fine tune prompts using prompt-engineering. For instance, in the case where the agile software development application is JIRA®, the AI bot platform 114 may generate a prompt for an AI bot 114, such as “You are the Security_Engineer. Your role is to review the user story and provide feedback from an enterprise security point of view. Suggest any subtasks needed for this story to be secure and policy compliant.” Further, the AI bot platform 114 may generate a prompt for an AI bot 113, such as “The Scrum_Master is your team manager. Ask the researched for policy related to encryption and security.” Further still, the AI bot platform 114 may generate rules for the AI bot 114, such as “Keep it short. Get to the point. Be straightforward. Always specify your recipient's name. Use function called retrieve_content to retrieve policy information before replying. Only reply if messages are prefixed with your name, i.e., Security_Engineer.”

According to an embodiment, the AI platform 112 may store results of the AI bots 114 in the database 118 (e.g., a vector database), and modify the output based on user feedback.

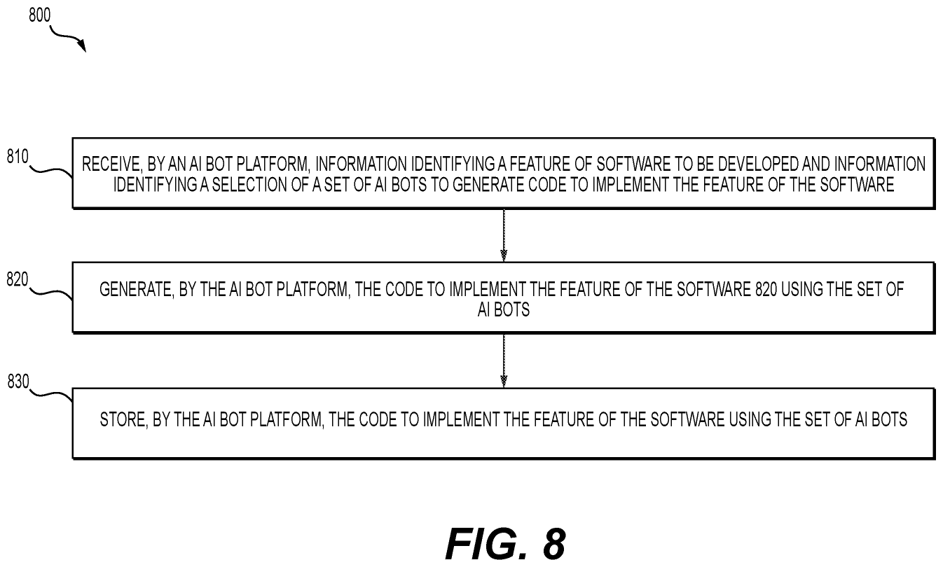

FIG. 8 is a flowchart of an example process 800 for generating code to implement a feature of software using a set of AI bots.

As shown in FIG. 8, the process 800 may include receiving, by an AI bot platform, information identifying a feature of software to be developed and information identifying a selection of a set of AI bots to generate code to implement the feature of the software (operation 810). For example, the AI bot platform 112 may receive information identifying a feature of software to be developed in order to generate code to implement the feature.

As further shown in FIG. 8, the process 800 may include generating, by the AI bot platform, the code to implement the feature of the software using the set of AI bots (operation 820). For example, the AI bot platform 112 may generate the code to implement the feature using the set of AI bots 114. In this case, the set of AI bots 114 may be configured to analyze the information identifying the feature, and generate code to implement the feature. The set of AI bots 114 may generate the code using a code generation technique, using code templates, or the like. According to an embodiment, the set of AI bots 114 may access code associated with the software from the database 120 (or a code repository), and generate the code based on accessing the code. In this case, the set of AI bots 114 may modify the accessed code in order to implement the feature.

As further shown in FIG. 8, the process 800 may include storing, by the AI bot platform, the code to implement the feature of the software (operation 830). For example, the AI bot platform 112 may store the code in the database 120, a code repository, or the like. In this way, the user device 102 may access the code. The software development team may review the code, modify the code, test the code, or the like.

In this way, some embodiments herein improve the accuracy of task delineation, reduce an amount of errors associated with task delineation, reduce the expertise needed for task delineation, reduce the amount of time needed for task delineation, etc. Further, in this way, some embodiments herein may result in software that is more comprehensive, that more sufficiently complies with various technical requirements, that is less error-prone, or the like.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

We claim:

1. A method comprising:
receiving information identifying a feature of software to be developed based on the information identifying the feature being input via an agile software development interface of a user interface of a user device;
receiving information identifying a set of artificial intelligence (AI) bots to generate information identifying a set of tasks associated with development of the feature of the software based on the information identifying the set of AI bots being input via an AI bot interface of the user interface of the user device;
generating the information identifying the set of tasks associated with the development of the feature of the software using the set of AI bots; and
transmitting the information identifying the set of tasks to the user device to cause the user device to display the information identifying the set of tasks via the agile software development interface of the user interface of the user device.

2. The method of claim 1, wherein the agile software development interface and the AI bot interface are concurrently displayed via the user interface of the user device.

3. The method of claim 1, wherein each bot of the set of AI bots is associated with a particular role related to the development of the feature of the software.

4. The method of claim 1, wherein a first AI bot, of the set of AI bots, is configured to generate a query to an AI platform, a data source, or a database to generate the information identifying the set of tasks.

5. The method of claim 1, wherein a first AI bot, of the set of AI bots, is configured to generate a query to a second AI bot, of the set of AI bots, to generate the information identifying the set of tasks.

6. The method of claim 1, wherein the information identifying the set of tasks includes respective tasks of a set of roles of a software development team associated with the development of the feature of the software.

7. The method of claim 1, further comprising:
generating code to implement the feature of the software using the set of AI bots; and
storing the code to implement the feature of the software.

8. A device comprising:
a memory configured to store instructions; and
one or more processors configured to execute the instructions to perform operations comprising:
receiving information identifying a feature of software to be developed based on the information identifying the feature being input via an agile software development interface of a user interface of a user device;
receiving information identifying a set of artificial intelligence (AI) bots to generate information identifying a set of tasks associated with development of the feature of the software based on the information identifying the set of AI bots being input via an AI bot interface of the user interface of the user device;
generating the information identifying the set of tasks associated with the development of the feature of the software using the set of AI bots; and
transmitting the information identifying the set of tasks to the user device to cause the user device to display the information identifying the set of tasks via the agile software development interface of the user interface of the user device.

9. The device of claim 8, wherein the agile software development interface and the AI bot interface are concurrently displayed via the user interface of the user device.

10. The device of claim 8, wherein each bot of the set of AI bots is associated with a particular role related to the development of the feature of the software.

11. The device of claim 8, wherein a first AI bot, of the set of AI bots, is configured to generate a query to an AI platform, a data source, or a database to generate the information identifying the set of tasks.

12. The device of claim 8, wherein a first AI bot, of the set of AI bots, is configured to generate a query to a second AI bot, of the set of AI bots, to generate the information identifying the set of tasks.

13. The device of claim 8, wherein the information identifying the set of tasks includes respective tasks of a set of roles of a software development team associated with the development of the feature of the software.

14. The device of claim 8, wherein the operations further comprise:
generating code to implement the feature of the software using the set of AI bots; and
storing the code to implement the feature of the software.

15. A non-transitory computer-readable medium storing instructions that, when executed by one or more processors of a device, cause the one or more processors to perform operations comprising:
receiving information identifying a feature of software to be developed based on the information identifying the feature being input via an agile software development interface of a user interface of a user device;
receiving information identifying a set of artificial intelligence (AI) bots to generate information identifying a set of tasks associated with development of the feature of the software based on the information identifying the set of AI bots being input via an AI bot interface of the user interface of the user device;
generating the information identifying the set of tasks associated with the development of the feature of the software using the set of AI bots; and
transmitting the information identifying the set of tasks to the user device to cause the user device to display the information identifying the set of tasks via the agile software development interface of the user interface of the user device.

16. The non-transitory computer-readable medium of claim 15, wherein the agile software development interface and the AI bot interface are concurrently displayed via the user interface of the user device.

17. The non-transitory computer-readable medium of claim 15, wherein each bot of the set of AI bots is associated with a particular role related to the development of the feature of the software.

18. The non-transitory computer-readable medium of claim 15, wherein a first AI bot, of the set of AI bots, is configured to generate a query to an AI platform, a data source, or a database to generate the information identifying the set of tasks.

19. The non-transitory computer-readable medium of claim 15, wherein a first AI bot, of the set of AI bots, is configured to generate a query to a second AI bot, of the set of AI bots, to generate the information identifying the set of tasks.

20. The non-transitory computer-readable medium of claim 15, wherein the information identifying the set of tasks includes respective tasks of a set of roles of a software development team associated with the development of the feature of the software.
